(19) United States
(12) Patent Application Publication
(10) Pub. No.: US 2014/0088981 A1
(43) Pub. Date: Mar. 27, 2014

(54) SYSTEMS AND METHODS FOR PROACTIVE IDENTIFICATION OF FORMULARY CHANGE IMPACTS

(71) Applicant: MEDLMPACT HEALTHCARE SYSTEMS, INC., San Diego, CA (US)

(72) Inventor: Paul M. Momita, San Diego, CA (US)

(73) Assignee: MEDIMPACT HEALTHCARE SYSTEMS, INC., San Diego, CA (US)

(21) Appl. No.: 13/624,658

(22) Filed: Sep. 21, 2012

(51) Int. Cl. G06Q 50/22

(52) U.S. Cl. 705/2

(57) ABSTRACT

Systems and methods for proactively identifying impacts and making recommendations regarding modifications to a drug formulary are provided. In an embodiment, a proposed modification to a formulary is received. One or more data sources are accessed, and an impact of the proposed modification to the formulary is determined based on the one or more data sources. The impact of the proposed modification is then provided to a user prior to implementation of the proposed modification.

### BACKGROUND

1. Field of the Invention

The present invention relates generally to prescription drug benefits programs, and, more particularly, to proactively identifying impacts, recommendations, and/or optimizations related to the modification of a drug formulary.

2. Related Art

Conventional systems for electronic claims adjudication by pharmacy benefits management (“PBM”) companies have been around for some time. A PBM is an administrator of prescription drug benefits programs. PBMs are primarily responsible for adjudication and paying claims for covered prescription drugs that are purchased by consumers who are members of the prescription drug benefits program. Other typical PBM services include developing and maintaining the drug formulary (i.e., the list of drugs covered by the prescription drug benefits program, their associated tiers, and/or utilization management rules), contracting with pharmacies, and negotiating discounts and rebates with drug manufacturers.

Conventional PBM claim adjudication systems are typically employed when a member attempts to purchase a drug and the drug purchase is to be wholly or partially covered by a prescription drug benefits program. A prescription drug benefits program may be provided to the member through an employer health plan (e.g., ERISA plans, self-insured employer group plans, managed care plans, Taft-Hartley trust plans, etc.), a privately purchased health plan, a government sponsored health plan (e.g., Medicare, Medicaid, or any other city, state, local, or federal government plan), or directly from a PBM provider.

In a typical drug purchase transaction, the originating entity (e.g., a pharmacy) electronically transmits a claim through a switch company to the PBM for adjudication of the claim. The PBM adjudicates the claim to validate, among other things, that the member prescription drug benefits program is valid, that the prescribing doctor is valid, and that the drug to be purchased is covered by the prescription drug benefits program. The PBM sends an electronic response back to the pharmacy that either denies the transaction or approves the transaction. If the transaction is approved, the response may comprise additional information, such as a co-payment amount.

Drug formularies today are typically developed and managed by a single entity. The formulary may be developed and managed by a PBM company or by a customer of the PBM company (e.g., an insurance company). A committee of the PBM, customer, or other entity may be charged with developing, managing, updating, and administering a formulary. The committee may comprise primary care physicians, specialty physicians, pharmacists, nurses, legal experts, administrators, and/or other professionals in the healthcare field, and is often independent of the benefit plan sponsor and vetted for conflicts of interest. The committee may also design and implement utilization management rules, such as quantity limits, step therapy, prior authorizations, and the like.

Many managed care organizations use a tiered design, whereby each drug in the formulary is assigned to a tier. The tier represents the level of coverage provided by the benefits program. The most cost-effective drugs (e.g., generics) are generally assigned to the most preferred tier and have the lowest patient out-of-pocket costs (i.e., co-payments). Conversely, the least cost-effective drugs are generally assigned to the least preferred tier and have the highest co-payments, or are not covered (e.g., excluded from the formulary). During claim adjudication, the formulary is consulted to determine whether or not a particular drug is covered, what utilization management rules may apply, and which program tier is associated with the drug.

From time to time, it may be necessary or desirable to update or modify a formulary, for instance, to add, remove, or otherwise change drug entries, tiers, and/or utilization management rules. Formulary management allows a formulary manager (e.g., a PBM company, large company, or health plan) to create and update formulary content to meet ever changing clinical and business needs. However, the formulary change process (e.g., inclusion or exclusion of a particular drug, modification of drug tiers and/or utilization management rules) is typically challenging due to the lack of readily accessible information. Such changes may have wide-ranging impacts, including economic impacts and member disruption. For example, the removal of one drug from a formulary, may result in a reduction in rebates associated with that drug, as well as an increase in rebates associated with competing drugs, which may consequently experience an increase in market share due to the removal of the drug from the formulary. In addition, the removal of the drug from the formulary may also cause a disruption in benefits for plan members having prescriptions for the previously covered, but now excluded, drug.

Conventionally, changes to the formulary are written down on a paper form, which is manually reviewed to identify any possible downstream effects. The changes are then manually implemented by programmed changes to the formulary system rules, tested, and then deployed. Consequently, changes to the formulary require tedious and repeated manual updating and redefinition. This process can be costly, time-consuming, and mistake-ridden. Furthermore, in order to assess the impacts of a change in a drug formulary, each potential impact must be manually identified and individually assessed. Thus, an operator of a drug formulary may not be willing to expend the time and effort necessary to manually identify and accurately assess all potential impacts of a formulary change. This, in turn, can lead to suboptimal decisions, and may result in unanticipated impacts.

In addition, there is currently no system or method for automatically identifying and evaluating alternative changes to a formulary which may achieve the same or a similar objective as a proposed change, but with less overall impact. Furthermore, there is currently no system or method for proactively optimizing an existing formulary, for example, to achieve an optimum economic efficiency.

### SUMMARY

Accordingly, systems and methods are disclosed for overcoming these deficiencies in current formulary management tools.

In an embodiment, a method of identifying impacts of a proposed modification to a formulary is disclosed. The method comprises receiving a proposed modification to a formulary; accessing one or more data sources; determining an impact of the proposed modification to the formulary based on the one or more data sources; and providing the impact of the proposed modification to a user prior to implementation of the proposed modification.

In an additional embodiment, a system for identifying impacts of a proposed modification to a formulary is disclosed. The system comprises: at least one hardware processor; and at least one executable software module that, when executed by the at least one hardware processor, receives a proposed modification to a formulary, accesses one or more data sources, determines an impact of the proposed modification to the formulary based on the one or more data sources, and provides the impact of the proposed modification to a user prior to implementation of the proposed modification.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings, in which like reference numerals refer to like parts and in which:

FIG. 1 illustrates a formulary management system, according to an embodiment;

FIG. 2 illustrates a example modules of a formulary management system, according to an embodiment;

FIG. 3 illustrates an example claims adjudication system, according to an embodiment; and

FIG. 4 illustrates an example processing device that may be used in connection with various embodiments described herein.

### DETAILED DESCRIPTION

Certain embodiments disclosed herein provide for proactive impact assessments, recommendations, and/or optimizations for drug formularies. For instance, the systems and methods disclosed herein may integrate and leverage multiple sources of downstream data to provide assessments and/or recommendations to a formulary manager in a proactive fashion, in order to improve decision support and enable the formulary manager to make optimal formulary management decisions in an efficient manner. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

A plurality of different entities may develop and maintain their own formularies. For example, these entities may include PBMs, clients of PBMs (e.g., ERISA plans, self-insured employer group plans, managed care plans, Taft-Hartley trust plans, etc.), and any other entity capable of developing and maintaining a formulary. A formulary may comprise one or more components. Each component can comprise a grouping of one or more drugs, which is sometimes called a “drug bucket.” Each component may also be associated with one or more attributes, which may include tiers associated with drugs or subsets of drugs within the component, utilization management rules which apply to drugs or subsets of drugs within the component, and the like.

In an embodiment, a user interface is provided for formulary management, including formulary change management, which may be integrated into existing formulary management tools. The user interface may be a web-based user interface, such as a webpage or set of webpages which utilize HyperText Markup Language (HTML), and may be either static, dynamically-generated, or comprise both static and dynamically-generated elements. The user interface may be hosted on one or more web servers or other servers, and may be served by the servers over one or more networks (e.g., the Internet) using standard communications protocols (e.g., Hypertext Transfer Protocol (HTTP), Secure HTTP (HTTPS), and the like). The user interfaces may include one or more types of content, such as inputs, web forms, images, text, hyperlinks, and the like. A user may interact with the user interface using the inputs included in the user interface. These inputs may include buttons, checkboxes, radio buttons, text boxes or areas, references (e.g., hyperlinks), scroll bars, drop-down boxes, file uploads, and the like. Information, such as requests and/or data, may be transmitted from the user to the server(s) using standard communication protocols and request methods, including standard POST and GET methods. Likewise, responses to these requests may be transmitted from the server(s) to the user using the same standard communication protocols. Data, including system data, formulary data, configuration data, user data, and the like, can be stored in one or more files, directories, databases, or other data structures that are either locally or remotely accessible by the server(s).

A user interacts with the user interface to generate one or more potential changes to a managed formulary. For example, a change may include an inclusion of a previously uncovered drug, an exclusion of a previously covered drug, a change in the tiering of a covered drug, a change in a quantity limit of a covered drug, a change in a utilization management rule or in an application of a utilization management rule, and the like.

In an embodiment, the system has access to one or more sources of downstream data. Downstream data may include, without limitation, benchmarking information, rebate information, plan member information, and the like. Benchmarking information may comprise industry-wide or competitors' performance metrics, on a regional, national, or other geographic level, or for a particular industry segment or group of segments. Rebate information may comprise the terms of contracts that the PBM or benefits program has with drug manufacturers. For example, the rebate information may comprise associations between identifications of particular drugs in the benefits program and rebates that are applicable to those drugs. For example, the rebates may comprise amounts, quantity requirements, and other applicable rules or requirements. Member information may comprise plan information for each member of the benefits plan, including, for instance, past and/or current prescription information. It should be understood that this downstream data may be stored in one or more databases which are locally and/or remotely accessible by the system. Additionally or alternatively, some of the downstream data may be received by the system as a data feed, for example, from a web service using an application programming interface (API) and/or eXtensible Markup Language (XML).

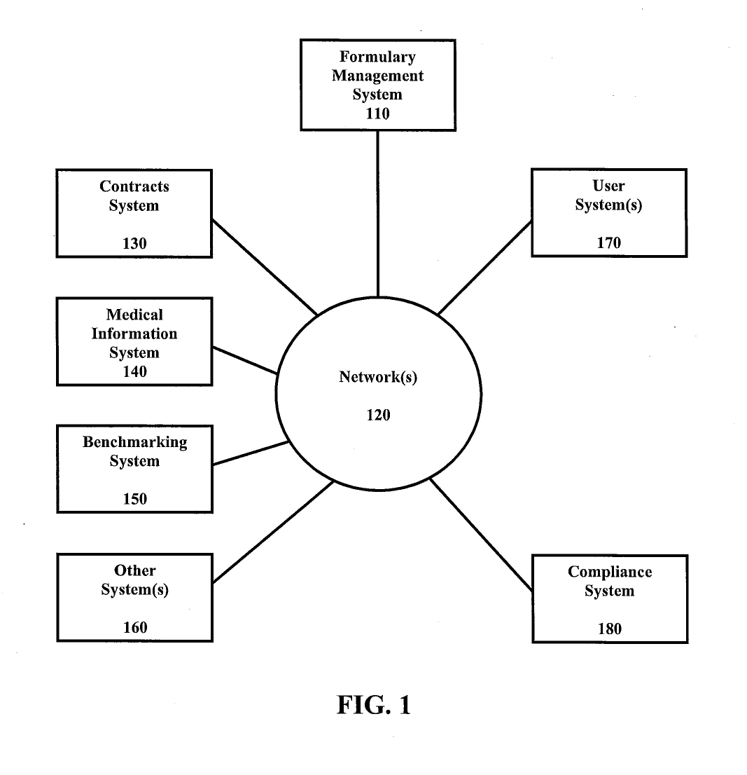

FIG. 1 illustrates a system for formulary management, according to an embodiment. In the illustrated embodiment, the formulary management system 110 is communicatively connected to one or more data sources through network(s) 120. Network(s) 120 may comprise one or more networks, including, for instance, an intranet and/or the Internet. In addition, while FIG. 1 illustrates the formulary management system 110 being connected to various systems through a single set of network(s), it should be understood that the formulary management system 110 may be connected to the various systems via different sets of one or more networks. For example, the formulary management system 110 may be connected to contracts system 130 and medical information system 140 via an intranet, but may be connected to the benchmarking system via the Internet. The data sources may comprise a contracts system 130, medical information system 140, benchmarking system 150, and/or any number of other systems 160. Systems 130, 140, 150, 160, and/or 180 may comprise one or more databases, web services, or other types of data sources.

Contracts system 130 may comprise data related to contractual obligations of and/or rebates available to the benefit plan(s) managed by formulary management system 110. For example, contracts system 130 may store obligations and/or rebates in association with identifiers of the drug entries to which they are applicable. This contract information may be automatically and/or manually extracted from paper, digital, or digitized contracts (e.g., between the benefit plan(s) and one or more drug manufacturers) and codified into a data set.

Medical information system 140 may comprise data related to members of the benefit plan(s) managed by formulary management system 110. Such data may comprise personal information and/or medical information, such as medical histories, prescription information, drug usage history, laboratory and test results, genetic information, and/or the like. In some embodiments, the medical information system 140 may not comprise or provide personally identifying information to formulary management system 110, in order to protect the privacy of members.

Benchmarking system 150 may comprise data related to the industry or competitors of the PBM company managing the formulary, the employer(s) utilizing the benefit plan(s) managed by the formulary management system 110, the benefit plan(s), or the like. For instance the data may comprise industry-wide performance metrics for other benefit plans or formularies. Alternatively or additionally, the data may comprise performance metrics for particular competitor(s) and/or industry segment(s). The data may also comprise information on competitors' formularies, market shares of drugs, and/or trends in the marketplace. The metrics may be available at the local, regional, and/or national level. For example, the performance metrics may comprise formulary revenues, net revenues, expenses, formulary status (e.g., inclusion, tier placement, utilization management placement), average cost per day, average quantity per day, and the like.

It should be understood that formulary management system 110 may interface with one or more other data sources 160. For example, the formulary management system 110 may be interfaced with the general PBM system and/or a data warehouse. Additionally or alternatively, formulary management system 110 may be communicatively connected with compliance system 180. Compliance system 180 may ensure that modifications to the formulary are compliant with contractual requirements, regulatory requirements, PBM requirements, and the like. Compliance system 180 may also house Centers for Medicare & Medicaid Services (CMS) Medicare Part D formulary rules. The system 180 could warn a user if the proposed changes would violate one or more of these CMS formulary rules. For example, CMS formulary rules may include a requirement that there be at least two drugs in the formulary for every therapeutic category and class, may prohibit the application of certain types of utilization management rules to certain types of drugs, and/or may, for protected class agents, only permit application of utilization management rules to beneficiaries who are not currently utilizing a drug (i.e., new starts only).

In an embodiment, formulary management system 110 is communicatively connected (e.g., via network(s) 120) with one or more user systems 170. User system 170 may comprise a personal computing device (e.g., desktop computer, laptop computer, tablet computer, mobile communication device, etc.) which interacts with a web server of formulary management system 110 via network 120 (e.g., Internet) using an application, such as a browser application. As is well-known in the art, user system 170 or a user of user system 170 may be required to authenticate with formulary management system 110 (e.g., using a user identifier and password, digital certificates, etc.) prior to accessing protected resources of formulary management system 110.

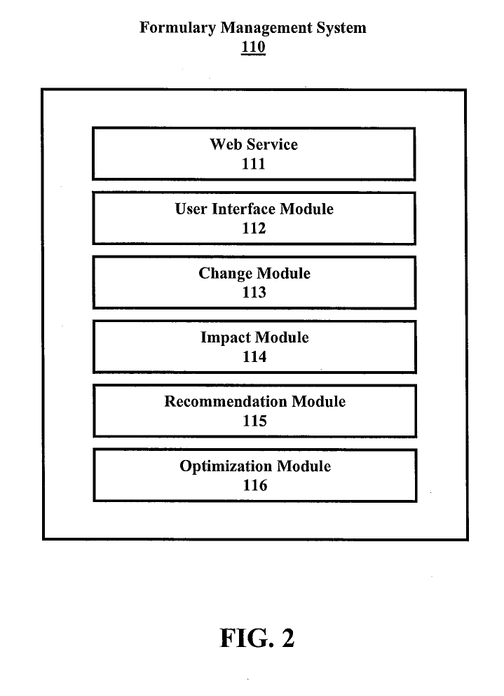

FIG. 2 illustrates a formulary management system, according to an embodiment. By way of illustration and not limitation, the formulary management system 110 may comprise a web service 111, a user interface module 112, a change module 113, an impact module 114, a recommendation module 115, and an optimization module 116. It should be understood that the formulary management system 110 may comprise more or fewer modules and/or a different arrangement of modules.

Web service 111 responds to requests from, for example, user system(s) 170. For example, the requests may comprise user interfaces (e.g., web pages) or data (e.g., in XML format). Web service 111 may be integrated or interfaced with user interface module 112, which may provide and/or generate web pages or other user interfaces, and/or perform actions, in response to user requests from user system(s) 170. For example, user interface module may comprise server pages (e.g., JavaServer Pages, Active Server Pages, etc.) for the dynamic generation of content. User interface module 112 may also comprise one or more servlets to handle requests (e.g., POST requests) from the user system(s) 170. In an embodiment, user interface module 112 can comprise a wizard or other series of interfaces which guides a user through a series of questions, steps, queries, prompts, selections, choices, or other interactions to create or modify a formulary managed by formulary management system 110, review impacts of modifications to a formulary, and review and/or approve recommendations of alternative modifications or optimizations to a formulary.

In an embodiment, change module 113 provides functions for modifying a formulary being managed by formulary management system 110. For example, change module 113 may be interfaced with user interface module 112, to receive and confirm changes to the formulary inputted by a user through a user interface provided by user interface module 112. Change module 113 may also be interfaced with or have access to impact module 114, recommendation module 115, and/or optimization module 116.

In an embodiment, impact module 114 receives modification information from change module 113. The modification information may comprise one or more changes being proposed for a managed formulary, and inputted through user interface module 112. In an embodiment, execution of impact module 114 is automatically performed after proposed modification(s) to the formulary are inputted but before they are confirmed or approved. Impact module 114 may retrieve or receive data from contracts system 130, medical information system 140, benchmarking system 150, other systems 160, and/or compliance system 180. This data may be retrieved or received in real time. Impact module 114 may then analyze the proposed changes from change module 113. Based on the data retrieved from systems 130, 140, 150, 160, and/or 180, impact module 114 determines negative and/or positive impacts which would result from the proposed changes.

For instance, impacts may include without limitation, the number of members who will be affected by the modification(s), the positive or negative impact on rebates, potential breaches of contract resulting from the modification, projected market share shifts, project net cost changes, and the like.

By way of illustration and not limitation, an example process of impact assessment will now be described. A user of formulary management system 110 may input a proposed modification comprising the exclusion of a drug that was previously included in a formulary. The impact module 114 may retrieve marketplace information from benchmarking system 150 and/or other system(s) 160. This marketplace information may comprise market share information, including the market share for one or more drugs that compete or are substitutes for the drug to be excluded by the modification. Impact module 114 may determine which competing drug(s) are included in the formulary, and, based on predictive modeling or forecasting, predict the shift in market share (e.g., an increase in percentage market share) that each of the included competing drug(s) will experience as a result of the proposed exclusion. Impact module 114 may also access contracts system 130 to obtain rebate information related to the drug to be excluded and the included competing drug(s). Based on this rebate information, impact module 114 may determine the total impact on rebates that will result from the proposed exclusion. For instance, impact module 114 may determine that exclusion of the drug will result in a reduction in rebates for the drug to be excluded equal to a monetary value of X, but that the increased utilization of the included competing drug(s) will result in an increase in rebates from the manufacturer(s) of the included competing drug(s) equal to a monetary value of Y. If Y>X, then impact module 114 may determine that the proposed exclusion will result in a positive economic impact of Y-X. Otherwise, if X>Y, the impact module 114 may determine that the proposed exclusion will result in a negative economic impact of X-Y. In addition, impact module 114 may retrieve member information from medical information system 140. Based on this member information, impact module 114 may determine the number of members currently utilizing the drug to be excluded. Thus, impact module 114 may also determine that the proposed exclusion will result in the disruption of a number of members equal to Z. Impact module 114 may also retrieve benchmarking information from benchmarking system 150. The benchmarking information may comprise market trends, competitor information, and the like, which can aid a user in determining how the managed formulary is aligned (or not aligned) with peers (e.g., competitors) in the industry. For instance, impact module 114 may determine whether the proposed exclusion is trending, common, or uncommon among peers. Accordingly, impact module 114 may provide the economic impact, amount of member disruption, and marketplace trends related to the proposed exclusion to a user of formulary management system 110, for example, via user interface module 112. The user may then review the impacts and either approve or reject the proposed exclusion. In an embodiment, if the user approves the proposed exclusion, formulary management system 110 may interface with a downstream communication module or platform to facilitate notification (e.g., via email, letter, text message, phone call, etc.) of any members who are or may be affected by the modification.

While the impact module 114 may determine that the exclusion or inclusion of a drug will result in a reduction or increase in rebates and/or will violate a rebate contract, it should be understood that impact module 114 may be configured to handle more complex cases as well. For example, a rebate contract may incorporate market share thresholds to achieve certain rebate payment target amounts. Impact module 114 may integrate components of benchmarking and forecasting (e.g., from systems 140, 150, 160, and/or 180) alongside the rebate contract data to project a revised market share for a particular drug based on one or more proposed formulary changes. Impact module 114 may then project how the revised market share may positively or negatively impact both rebate payment thresholds and net cost opportunities.

In an embodiment, recommendation module 115 receives one or more goals or objectives from a user, for example, though user interface module 112. For example, an objective may be to reduce costs or increase net revenue, minimize member disruption, achieve a clinical quality goal, align with competitors, differentiate from competitors, and the like. The objective(s) may be received as an input in conjunction with proposed changes from the change module 113, or it may be received as an individual input and/or directly by recommendation module 115. Alternatively, recommendation module 115 may automatically determine objective(s) based on the modifications inputted to the change module 113. Additionally or alternatively, a user of formulary management system 110 may establish a set of one or more criteria. For example, the criteria may comprise a highest cost savings with a least number of member disruptions, while remaining within 80% of average benchmarking drug coverage within a therapeutic class. The criteria may be weighted (e.g., mandatory, non-mandatory), such that the recommendation may attempt to adhere to one criterion more than another. Recommendation module 115 may then identify formulary modifications which achieve the highest positive impact based on the one or more weighted and/or unweighted criteria.

Recommendation module 115 can operate much like impact module 114. However, recommendation module 115 is configured to evaluate the impacts of one or more alternative formulary modifications that achieve the same or a similar objective(s) to the specified objective(s) and/or the user-proposed modification(s). For example, recommendation module 115 may automatically identify and assess the impacts of a plurality of sets of one or more potential modifications to a formulary.

In an embodiment, the recommendation module 115 presents the alternative formulary modifications to a user through user interface module 112. Recommendation module 115 may be configured to only present a set of one or more alternative formulary modifications which achieve the same or a similar objective as the user-proposed change with less overall impact, and/or with less impact in a particular aspect (e.g., less economic impact, less member disruption, etc.). Recommendation module 115 may be executed automatically whenever a proposed modification is inputted by a user, and the recommendations may be provided to the user in conjunction with the impact(s) determined by impact module 114. In such an embodiment, the recommendation module 115 may be executed either serially or in parallel with impact module 114.

In an embodiment, optimization module 116 is similar in function and/or implementation to recommendation module 115 and/or impact module 114. Similarly to the recommendation module 115, optimization module 116 may be configured to evaluate the impacts of one or more formulary modifications that achieve one or more objectives or goals. The objective(s) may be established by a user of formulary management system 110. For example, the objective(s) may comprise a positive economic impact (e.g., reduced costs, increased rebates, etc.), minimization of member disruption, and the like. As with recommendation module 115, the objective(s) may comprise a set of one or more weighted and/or unweighted criteria. Optimization module 116 may then identify formulary modifications which achieve the highest positive impact based on the one or more weighted and/or unweighted criteria. Optimization module 116 may be configured to determine a predetermined number of optimizing sets of one or more modifications (e.g., a “Top 10”). In an embodiment, optimization module 116 may be configured to assess the formulary for potential optimizing modifications on an automatic, periodic basis (which may be a system or user setting) and/or in response to a user request. Optimization module 116 may present the identified optimizing modifications—and optionally, their associated impacts—to a user of the formulary management system 110 (e.g., via user interface module 112) for consideration and/or approval.

In an embodiment, formulary management system 110 may also comprise one or more downstream modules, or may be integrated or otherwise communicatively connected with one or more downstream systems or platforms to facilitate the implementation of changes. For example, impact module 114 may identify one or more members who may be impacted by a proposed change. Then, once these changes have been approved, system 110 may instruct or otherwise cause a downstream communication module or platform to inform impacted members about the impending change (e.g., via email, postal mail, telephone call, etc.). As an additional example, one or more integrated or connected downstream modules or platforms may implement approved changes, for example, by making the modifications (e.g., which have been input to change module 113) to the formulary.

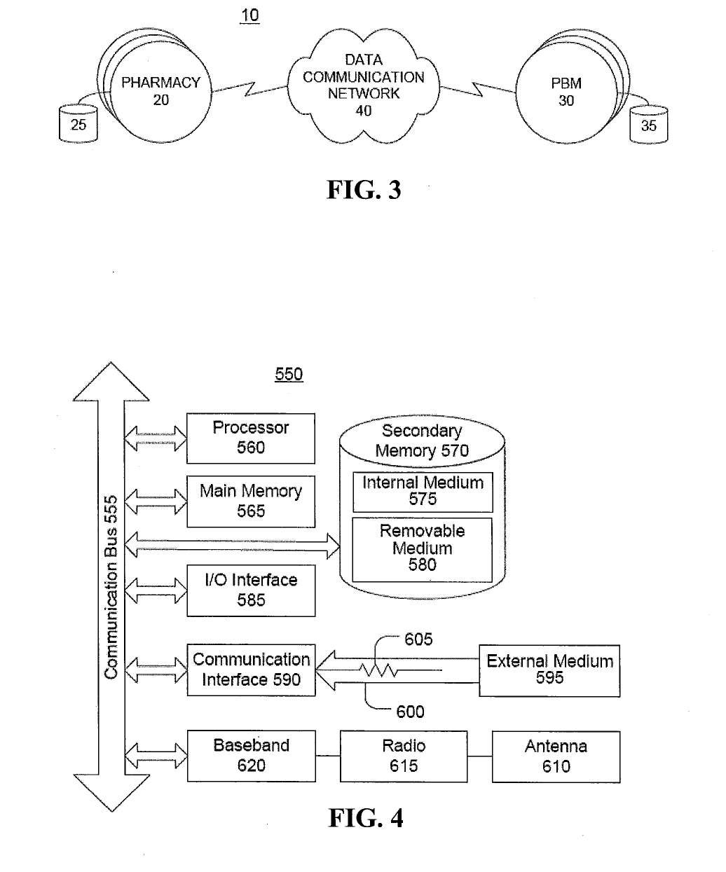

FIG. 3 illustrates a network diagram of a claims adjudication system, which may be used for adjudicating claims according to a formulary. The system 10 comprises a pharmacy 20 that is communicatively coupled with PBM 30 via a data communication network 40, which may include the Internet. The system 10 may include more than one pharmacy 20 and more than one PBM 30.

The pharmacy 20 can be a brick-and-mortar store, an online ecommerce website or application, or any other sort of entity, system, or device that is capable of handling a member's prescription drug purchase transaction. The pharmacy 20 may include one or more processor-enabled communication devices (not shown) that are capable of communicating with the PBM 30 over the network(s) 40 and storing data in and retrieving data from the data storage area 25. The data storage area 25 may include any form of memory, including volatile and non-volatile memory. In one embodiment, the data storage area 35 includes non-transitory computer-readable media. Example architectures that can be employed for such communication devices are described later with respect to FIG. 4.

Similarly, the PBM 30 may include one or more processor-enabled communication devices (not shown) that are capable of communicating with the pharmacy 20 over the network(s) 40 and storing data in and retrieving data from the data storage area 35. The data storage area 35 may include any form of memory, including volatile and non-volatile memory. In one embodiment, the data storage area 35 includes non-transitory computer-readable media. Example architectures that can be employed for such communication devices are describe later with respect to FIG. 4.

The network(s) 40 may include a variety of communication infrastructure, including without limitations, direct wired connections, personal area networks, local area networks, wide area networks, metropolitan area networks, telephone networks, the Internet, and any other communication infrastructure. The network(s) 40 may be wired or wireless and may also be capable of transmitting voice or data traffic or a combination of voice and data traffic. The network(s) 40 may also be public or private or a combination of public and private, and may transmit information using a variety of protocols, as is understood by those skilled in the art.

In one embodiment, the data communication network(s) 40 include a switch (not shown) that operates in the communication infrastructure between the pharmacy 20 and the PBM 30 and serves to electronically route prescription drug purchase claims to the appropriate PBM 30 based on member-provided information (e.g., a prescription drug benefits program card, or other eligibility data or evidence of coverage).

In operation of the system 10, a member of a prescription drug benefits program attempts to purchase a prescribed drug at the pharmacy 20. The pharmacy 20 collects certain information from the member to validate the prescription drug purchase transaction (also referred to herein as a “claim”). For example, this information may be obtained from the member's prescription drug benefits program card or health plan card. The pharmacy 20 sends an electronic claim adjudication request to the PBM 30 via the network(s) 40. The claim adjudication request seeks approval of the drug purchase transaction from the PBM 30. The PBM 30 adjudicates the claim based on the request and a formulary to validate or determine various elements related to the claim. For example, these elements related to the claim may include, without limitation, enrollment status of the member in the prescription drug benefits program, other member information, inclusion of the drug to be purchased on the formulary, the quantity of the drug to be purchased (e.g., as limited by the utilization management rules of the formulary), the amount of the member co-payment (e.g., as determined by consultation of the formulary), benefit design, pharmacy network, other restrictions imposed by the utilization management rules of the formulary, etc.

During claim adjudication, the PBM 30 analyzes information relevant to the particular claim being adjudicated. During the analysis, the PBM 30 determines, at least in part based on a formulary, whether the claim will be denied or approved. If the claim will be approved, the PBM 30 further utilizes the formulary to determine the tier at which the claim will be adjudicated. If the claim will be denied, in some embodiments, the PBM 30 may determine if the tier level will be overridden. Upon completion of the claim adjudication process, the PBM 30 provides the results of the claim adjudication to the pharmacy 20 in response to the claim adjudication request.

The systems and methods disclosed herein may be used to manage a formulary for claims adjudication for prescription drug benefits programs. It should be understood that embodiments of the disclosed formulary management processes and systems may be used in conjunction with any claims adjudication process or system. For instance, some embodiments of the disclosed systems and methods may be used in conjunction with the systems and methods disclosed in U.S. patent application Ser. No. 12/913,685, entitled “Dynamic Claims Adjudication,” filed Oct. 27, 2010, and published May 3, 2012 as U.S. Patent Publication No. 2012/0109839, which is hereby incorporated herein by reference. Additionally or alternatively, embodiments of the disclosed systems and methods may be used in conjunction with the systems and methods disclosed in U.S. patent application Ser. No. 13/207,203, entitled “System and Method for Overriding Claims,” and filed Aug. 10, 2011, the entirety of which is hereby incorporated herein by reference. Embodiments of the disclosed systems and methods may also be used in conjunction with the systems and methods disclosed in U.S. patent application Ser. No. 13/612,586, entitled “Systems and Methods for Generating and Managing a Hybrid Formulary” and filed Sep. 12, 2012, the entirety of which is hereby incorporated herein by reference.

FIG. 4 is a block diagram illustrating an example wired or wireless system 550 that may be used in connection with various embodiments described herein. For example the system 550 may be used as or in conjunction with modules for the management and change-impact assessment of a formulary, as previously described. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modern, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A computer-implemented method for identifying impacts of a proposed modification to a formulary, the method comprising, by at least one hardware processor:
receiving a proposed modification to a formulary;
accessing one or more data sources;
determining an impact of the proposed modification to the formulary based on the one or more data sources; and
providing the impact of the proposed modification to a user prior to implementation of the proposed modification.

2. The method of claim 1, further comprising:
identifying one or more alternative modifications to the formulary; and
providing the one or more alternative modifications to the user.

3. The method of claim 2, wherein identifying one or more alternative modifications to the formulary comprises:
determining an impact of each of a plurality of potential modifications to the formulary; and
identifying one or more alternative modifications from the plurality of potential modifications having an impact that is more positive than the impact of the proposed modification to the formulary.

4. The method of claim 1, further comprising:
determining an impact of each of a plurality of potential modifications; and
identifying one or more optimal modifications from the plurality of potential modifications having a most positive impact.

5. The method of claim 1, wherein the formulary comprises a plurality of drug entries, wherein the one or more data sources comprises rebate information for one or more of the plurality of drug entries, and wherein the impact comprises at least one of an increase in rebate amount or decrease in rebate amount.

6. The method of claim 1, wherein the one or more data sources comprise member information, and wherein the impact comprises a number of members affected by the proposed modification.

7. The method of claim 1, wherein the one or more data sources comprise marketplace information, and the method further comprises predicting a shift in market share, resulting from the proposed modification, based on the marketplace information.

8. The method of claim 1, wherein the proposed modification to the formulary is received from the user, and wherein the accessing, determining, and providing are performed automatically in response to receiving the proposed modification to the formulary from the user.

9. The method of claim 1, wherein the formulary comprises a plurality of drug entries, arranged in two or more tiers, and one or more utilization management rules.

10. The method of claim 1, further comprising receiving either an approval or disapproval of the proposed modification to the formulary.

11. A system for identifying impacts of a proposed modification to a formulary, the system comprising:
at least one hardware processor; and
at least one executable software module that, when executed by the at least one hardware processor,
receives a proposed modification to a formulary,
accesses one or more data sources,
determines an impact of the proposed modification to the formulary based on the one or more data sources, and
provides the impact of the proposed modification to a user prior to implementation of the proposed modification.

12. The system of claim 11, wherein the at least one executable software module further:
identifies one or more alternative modifications to the formulary; and
provides the one or more alternative modifications to the user.

13. The system of claim 12, wherein identifying one or more alternative modifications to the formulary comprises:
determining an impact of each of a plurality of potential modifications to the formulary; and
identifying one or more alternative modifications from the plurality of potential modifications having an impact that is more positive than the impact of the proposed modification to the formulary.

14. The system of claim 11, wherein the at least one executable software module further:
determines an impact of each of a plurality of potential modifications; and
identifies one or more optimal modifications from the plurality of potential modifications having a most positive impact.

15. The system of claim 11, wherein the formulary comprises a plurality of drug entries, wherein the one or more data sources comprises rebate information for one or more of the plurality of drug entries, and wherein the impact comprises at least one of an increase in rebate amount or decrease in rebate amount.

16. The system of claim 11, wherein the one or more data sources comprise member information, and wherein the impact comprises a number of members affected by the proposed modification.

17. The system of claim 11, wherein the one or more data sources comprise marketplace information, and the at least one executable software module further predicts a shift in market share, resulting from the proposed modification, based on the marketplace information.

18. The system of claim 11, wherein the proposed modification to the formulary is received from the user, and wherein the accessing, determining, and providing are performed automatically in response to receiving the proposed modification to the formulary from the user.

19. The system of claim 11, wherein the formulary comprises a plurality of drug entries, arranged in two or more tiers, and one or more utilization management rules.

20. The system of claim 11, wherein the at least one executable software module further receives either an approval or disapproval of the proposed modification to the formulary.

21. A computer-implemented method for optimizing a formulary, the method comprising, by at least one hardware processor:
receiving one or more criteria;
accessing one or more data sources;
identifying a plurality of potential modifications to the formulary;
determining one or more impacts of the plurality of potential modifications to the formulary based on the one or more data sources;
determining an optimal set of the plurality of potential modifications based on the one or more criteria; and
providing the optimal set of the plurality of potential modifications to a user.

22. The method of claim 21, wherein determining an optimal set of the plurality of potential modifications comprises determining a subset of the plurality of potential modifications which substantially achieves the one or more criteria with a most positive impact.

23. The method of claim 21, wherein the formulary comprises a plurality of drug entries, wherein the one or more data sources comprises rebate information for one or more of the plurality of drug entries, and wherein the one or more impacts comprise at least one of an increase in rebate amount or decrease in rebate amount.

24. The method of claim 21, wherein the one or more data sources comprise member information, and wherein the one or more impacts comprise a number of members affected by the one or more of the plurality of potential modifications.

25. The method of claim 21, wherein the one or more data sources comprise marketplace information, and the method further comprises predicting a shift in market share, resulting from one or more of the plurality of modifications, based on the marketplace information.

26. The method of claim 21, wherein the formulary comprises a plurality of drug entries, arranged in two or more tiers, and one or more utilization management rules.

27. The method of claim 21, further comprising receiving either an approval or disapproval of the optimal set of the plurality of potential modifications.
